(19) United States
(12) Patent Application Publication
(10) Pub. No.: US 2023/0232324 A1
(43) Pub. Date: Jul. 20, 2023

(54) DETECTING CONDITIONS FOR TARGET WAKE TIME PARAMETER ADJUSTMENT

(71) Applicant: Samsung Electronics Co., Ltd., Suwon-si (KR)

(72) Inventors: Guanbo Chen, McKinney, TX (US); Abhishek Sehgal, Plano, TX (US); Hao Chen, Plano, TX (US); Khuong N. Nguyen, Frisco, TX (US)

(21) Appl. No.: 18/147,650

(22) Filed: Dec. 28, 2022

Related U.S. Application Data
(60) Provisional application No. 63/299,771, filed on Jan. 14, 2022.

(51) Int. Cl. H04W 52/02

(52) U.S. Cl. CPC H04W 52/0216

(57) ABSTRACT

Methods and apparatuses for detecting conditions associated with a target wake time (TWT) parameter adjustment. A communication device comprises a transceiver and a processor operably coupled to the transceiver. The transceiver is configured to receive information including packets associated with a TWT. The processor is configured to determine a network service type based on the packets, and when the determined network service type is a real-time service type: determine whether a condition associated with the TWT is satisfied, and modify the TWT based on the condition.

### CROSS-REFERENCE TO RELATED APPLICATION(S) AND CLAIM OF PRIORITY

This application claims priority under 35 U.S.C. § 119(e) to U.S. Provisional Patent Application No. 63/299,771 filed on Jan. 14, 2022, which is hereby incorporated by reference in its entirety.

### TECHNICAL FIELD

This disclosure relates generally to efficiency in wireless communications systems. Embodiments of this disclosure relate to methods and apparatuses for detecting conditions associated with target wake time (TWT) parameter adjustment.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Target Wake Time (TWT) is one of the important features for power management in WI-FI networks, which was developed by IEEE 802.11ah and later adopted and modified into IEEE 802.11ax. TWT enables wake time negotiation between an AP and an associated station (STA) for improving power efficiency. With TWT operation, it suffices for a STA to only wake up at a pre-scheduled time negotiated with another STA or AP in the network. In IEEE 802.11ax standards, two types of TWT operation are possible—individual TWT operation and broadcast TWT operation. Individual TWT agreements can be established between two STAs or between a STA and an AP. On the other hand, with broadcast TWT operation, an AP can set up a shared TWT session for a group of STAs.

The negotiated parameters such as the wake interval, wake duration and initial wake time (offset) highly affect latency, throughput as well as power efficiency, which are directly related to QoS (quality of service) or customer experiences. Services with different traffic characteristics will have different TWT parameter configurations for better QoS. Additionally, the TWT configuration should adapt to network and service status variation.

### SUMMARY

Embodiments of the present disclosure provide methods and apparatuses for enabling detecting abnormal access point, bad network condition, and abnormal server for TWT parameter adjustment in a wireless network (e.g., a WLAN).

In one embodiment, a communication device is provided, comprising: a transceiver and a processor operably coupled to the transceiver. The transceiver is configured to receive information including packets associated with TWT. The processor is configured to determine a network service type based on the packets, and when the determined network service type is a real-time service type: determine whether a condition associated with the TWT is satisfied, and modify the TWT based on the condition.

In another embodiment, a method for operating a communication device is provided, the method comprising: receiving information including packets associated with TWT; determining a network service type based on the packets; and when the determined network service type is a real-time service type: determining whether a condition associated with the TWT is satisfied, and modifying the TWT based on the condition.

In another embodiment, a non-transitory computer readable medium is provided, the computer readable medium comprising instructions that, when executed by a processor, cause the processor to receive information including packets associated with TWT; determine a network service type based on the packets; and when the determined network service type is a real-time service type: determine whether a condition associated with the TWT is satisfied, and modify the TWT based on the condition.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates a diagram of packet exchange between devices according to embodiments of the present disclosure;

FIG. 4 illustrates an example TWT parameter set field used for TWT parameter negotiation according to embodiments of the present disclosure;

FIG. 5 illustrates an offset in a TWT session according to embodiments of the present disclosure;

FIG. 6 illustrates an example TWT information frame according to embodiments of the present disclosure;

FIG. 7 illustrates an example of early termination of TWT according to embodiments of the present disclosure;

FIG. 8 illustrates an example method for abnormal AP detection according to embodiments of the present disclosure;

FIG. 9 illustrates an example method for network service detection according to embodiments of the present disclosure;

FIG. 10 illustrates an example for confirming abnormal downlink inter-packet time according to embodiments of the present disclosure;

FIG. 11 illustrates a method for confirming abnormal downlink inter-packet time according to embodiments of the present disclosure;

FIG. 12 illustrates an example method for abnormal AP detection according to embodiments of the present disclosure

FIG. 13 illustrates an example method for network condition based TWT adjustment according to embodiments of the present disclosure; and

FIG. 14 illustrates an example method for abnormal server detection and TWT adjustment according to embodiments of the present disclosure.

### DETAILED DESCRIPTION

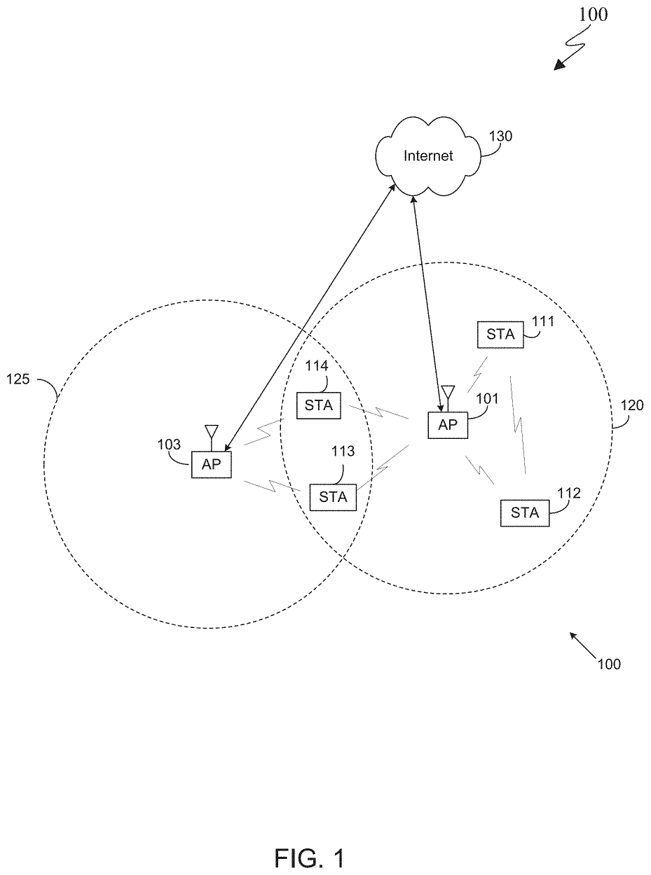

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that target wakeup time (TWT) can help save device power by setting a specific Station (STA) wakeup interval and the wakeup service period (SP), which can reduce the time/power consumption that STA is awake but has no data exchange to the Access Point (AP). The adjusted TWT parameters, including the TWT wakeup interval and the wakeup SP, need to meet the requirement that the overall throughput of the traffic is not impacted and little or no additional latency is introduced, while achieving a minimal duty cycle.

When TWT is negotiated, the TWT itself will inevitably introduce additional latency to the current network service. There can be three reasons which may lead to Quality of Service (QoS) issue after enabling TWT.

First, for some AP or STA, the TWT function may not work properly. Those problems can be caused by firmware or hardware problems within the AP or STA. Thus, a method needs to be developed to detect any abnormal AP and STA which has malfunctioned TWT, and then the TWT functions need to be disabled for those AP or STA.

Second, for some specific network service (such as mobile gaming etc.), if a bad network condition is discovered then it may lead to QoS issue when TWT is enabled. Thus, a method needs to be developed to detect those network services and the corresponding bad network condition, and then the TWT function needs to be disabled in this scenario.

Third, for some specific network service (such as mobile gaming etc.), sometimes, there can be problems with its network server. The bad server can cause delay and large latency in transceiving packets, and the TWT function in this scenario also needs to be turned off to avoid adding any extra latency to the communication chain. Thus, a method needs to be developed to detect the specific network service and whether the server of this network service is having any problem. If the network service's server is detected to behave abnormally, the TWT function needs to be turned off.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating triggered TXOP sharing for P2P communication during a TWT SP in a WLAN. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

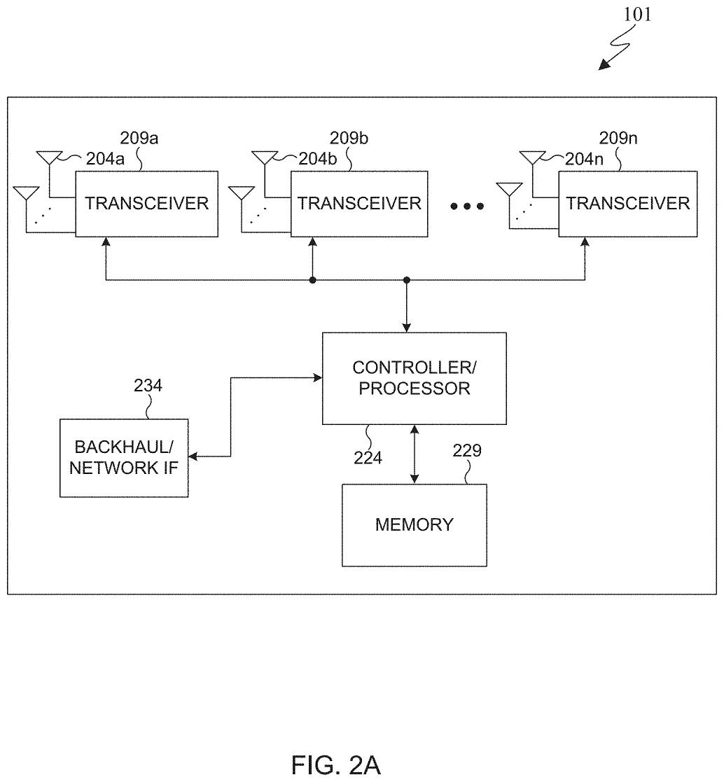

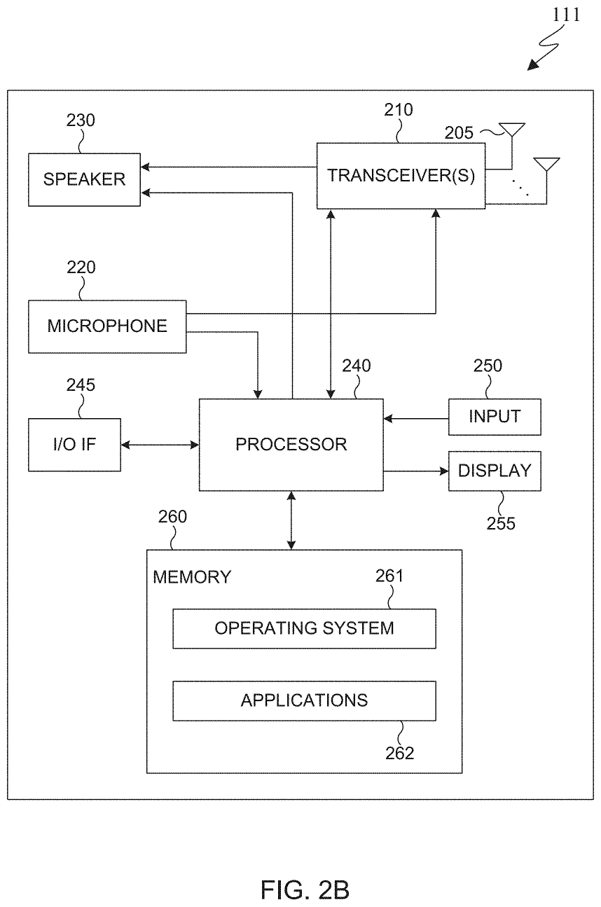

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating triggered TXOP sharing for P2P communication during a TWT SP. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating triggered TXOP sharing for P2P communication during a TWT SP. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives, from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate triggered TXOP sharing for P2P communication during a TWT SP. In some embodiments, the processor 240 includes at least one microprocessor or microcontroller.

The processor 240 is also capable of executing other processes and programs resident in the memory 260, such as operations for facilitating triggered TXOP sharing for P2P communication during a TWT SP. The processor 240 can move data into or out of the memory 260 as required by an executing process. In some embodiments, the processor 240 is configured to execute a plurality of applications 262, such as applications for facilitating triggered TXOP sharing for P2P communication during a TWT SP. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

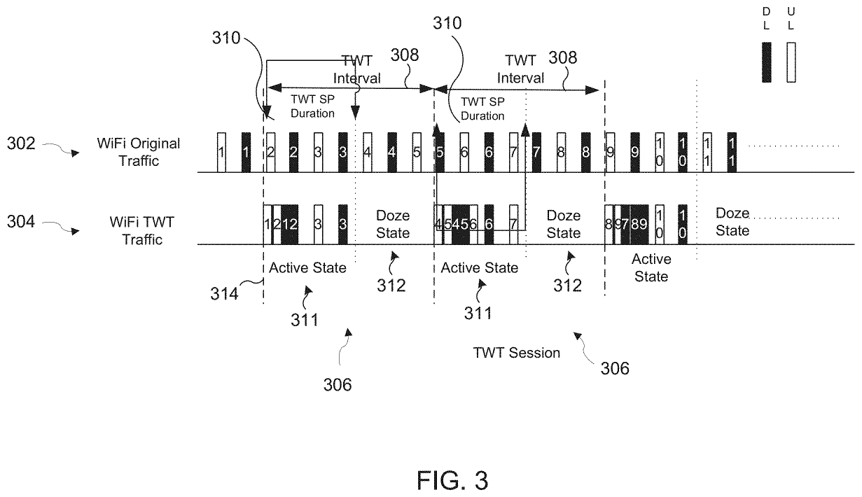

FIG. 3 illustrates a diagram of packet exchange between devices according to embodiments of the present disclosure. For the purposes of this disclosure, the figures will be discussed from the point of view of a STA, which may be an electronic device 101, but it is understood that it could be any suitable wireless communication device.

FIG. 3 illustrates two scenarios of exchange of uplink (UL) communication packets and downlink (DL) communication packets (which may be collectively referred to as traffic) between an AP and an associated STA. First, without wake time negotiation between the AP and the STA (e.g., as seen in the top graph 302), and second, with wake time negotiation between the AP and the STA (e.g., in an IEEE 802.11ax system and as seen in the bottom graph 304). In the top graph 302, there is a regular stream of non-buffered traffic between the AP and the STA, with UL packets being interspersed with DL packets. In this scenario (i.e., without wake time negotiation) there is no option for the STA to enter a doze state or a power save state.

By contrast, in the bottom graph 304, wake time negotiation gives rise to consecutive TWT sessions 306 (e.g., a service session). Each TWT session 306 is defined as the time period from the beginning of a TWT interval 208 to the end of the TWT interval 308. Each TWT session 306 includes two states: an active state 311, defined by a TWT service period (SP) duration 310 (during which the STA is awake to communicate with the AP), and a power save state or doze state 312 (during which the STA is not actively awake or communicating with the AP). As a result of wake time negotiation, power efficiency at the STA is improved without adding too much latency or allowing UL or DL packets to be dropped.

In wake time negotiation, the negotiated TWT parameters include the wake interval (e.g., the TWT interval 308 for each TWT session 306), wake duration (e.g., the TWT SP duration 310 for each TWT session 306), and initial wake time or offset (e.g., indicated by the TWT start time 314). These negotiated parameters highly affect latency, throughput, and power efficiency, which are directly related to the QoS (quality of service) a customer experiences. Services with different traffic characteristics can have different TWT parameter configurations for better QoS. Additionally, the TWT configuration should adapt to network and service status variation.

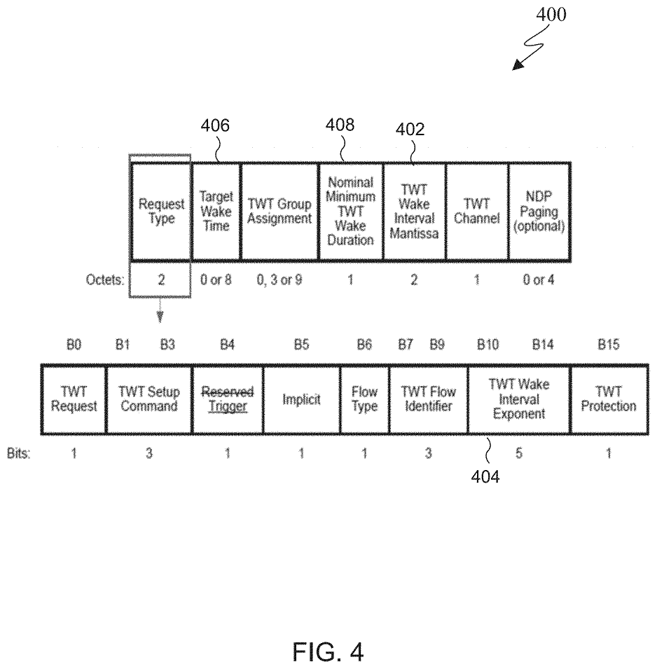

In some embodiments, a TWT parameter set field is used to negotiate the TWT parameters. FIG. 4 illustrates an example TWT parameter set field 400 used for TWT parameter negotiation according to embodiments of the present disclosure. The embodiment of the example TWT parameter field 400 illustrated in FIG. 4 is for illustration only. FIG. 4 does not limit the scope of this disclosure to any particular implementation of the example TWT parameter set field.

The TWT agreement is initiated by a STA sending a TWT negotiation request to an AP. Once a TWT agreement is made between the AP and the STA, the STA periodically wakes up to communicate with the AP, where the interval between the successive wake times is jointly specified by the TWT wake interval mantissa 402 and TWT wake interval exponent 404 sub-fields in the TWT parameter set field 400.

The target wake time 406 and nominal minimum TWT wake duration 408 sub-fields specify, respectively, the first wake time for the TWT agreement, and the time for which the STA must wait before going to doze state when there is no transmitted traffic after a wake time, which is the TWT SP duration 310 in FIG. 3.

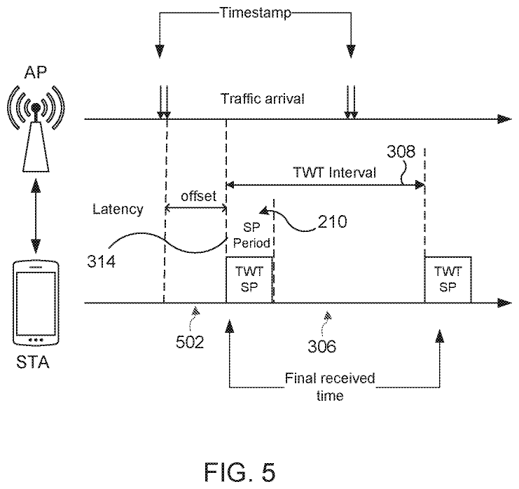

Other than the wake interval and wake duration, offset is also an important impact factor on the user experience, as the offset could affect the latency. FIG. 5 illustrates an offset in a TWT session according to embodiments of the present disclosure. The embodiment of the offset in a TWT session illustrated in FIG. 5 is for illustration only. FIG. 5 does not limit the scope of this disclosure to any particular implementation of the offset in a TWT session.

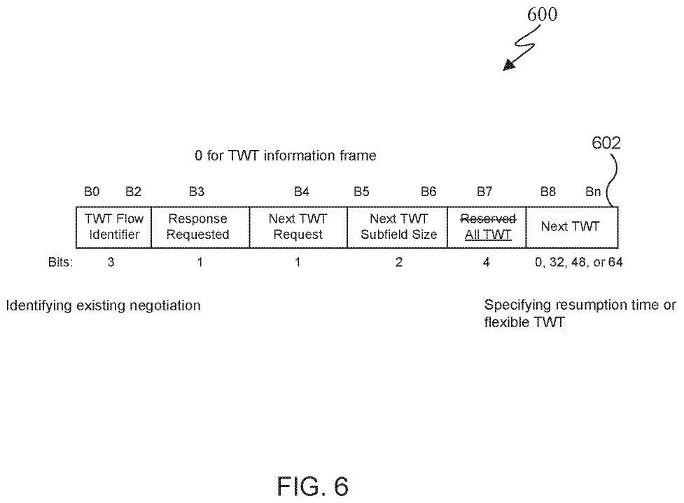

Different offsets 502 introduce a different additional TWT related latency. TWT interval 308 and offset together define the additional latency introduced by TWT. After TWT negotiation setup, the offset 502 can be adjusted by the field “Next TWT” 502 in the example TWT information frame 600 illustrated in FIG. 6. The embodiment of the example TWT information frame 600 illustrated in FIG. 6 is for illustration only. FIG. 6 does not limit the scope of this disclosure to any particular implementation of the example TWT information frame

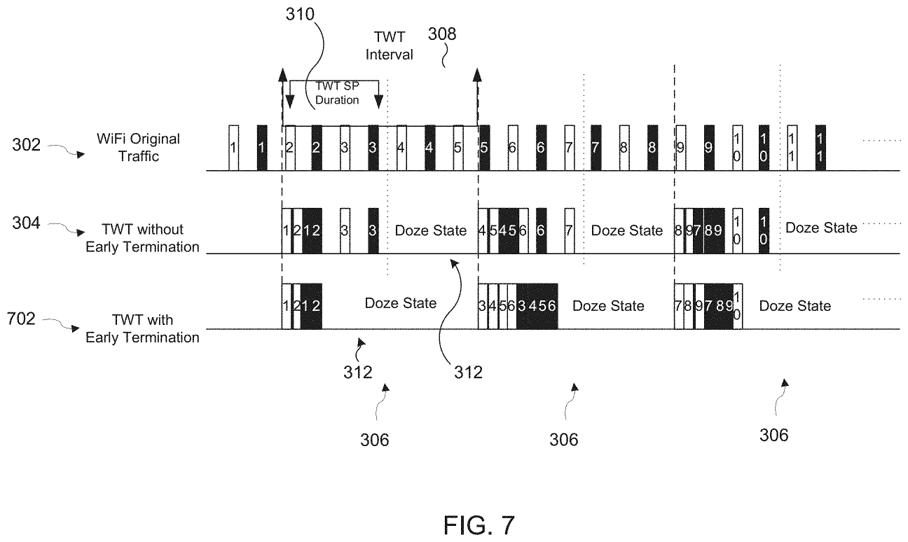

FIG. 7 illustrates an example of early termination of TWT according to embodiments of the present disclosure. The embodiment of the example of early termination of TWT illustrated in FIG. 7 is for illustration only. FIG. 7 does not limit the scope of this disclosure to any particular implementation of the example of early termination of TWT.

In various embodiments, the actual TWT SP duration 310 is dynamically determined in run time by the aforementioned nominal minimum TWT wake duration, and the STA enters the doze state 312 when a packet is received with EOSP (end of service period) bit set to “1”, or more data bit set to “0”. Depending on whether or not early termination is supported, the time the STA enters the doze state 312 will be slightly different. As shown in graph 702, if the STA supports early termination then once the STA receives a packet with EOSP bit set to “1” or more data bit “0” the STA can enter doze state 312 (although there could be a slight delay between reception of the packet and entering doze state 312). If the STA does not support early termination, then it will wait until end of TWT SP duration to enter doze state 312, as shown in graph 304.

In some embodiments, the type of traffic between a STA and AP can affect the optimal TWT parameters, and in particular the optimal TWT interval and TWT SP duration. Current methods of determining TWT parameters do not use information about the incoming traffic's statistics or estimate variation in the traffic statistics at a fine time scale (e.g., at the scale of a TWT interval, which can be in a range from about 20 ms to about 80 ms).

When the Access Point (AP) or Station (STA)'s TWT function is not working properly, the packets can be buffered at the AP side at the start of a TWT session and are not transmitted to the STA after a long time. These phenomena can lead to abnormally large downlink (DL) inter-packet time. The DL inter-packet time here is defined as the difference of the arrival time between two packets at the STA. In some instances, the two packets could be consecutive packets. In other instances, the arrival time could be the DL inter-packet time between two specific types of packets (e.g., two UDP packets, in which we would ignore the non-UDP packets coming in between).

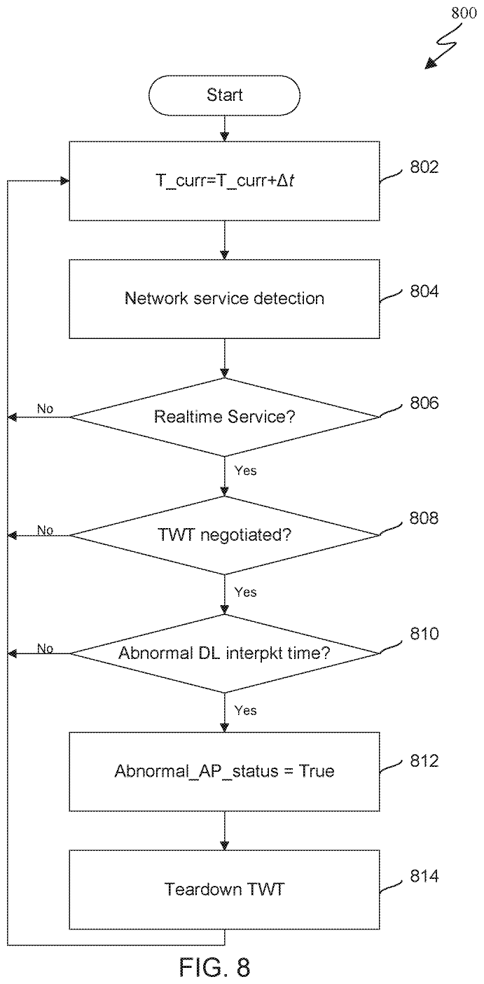

For real-time service, the normal DL inter-packet time can be relatively stable and small, and the DL inter-packet time is generally smaller. In the present disclosure, methods utilizing the downlink inter-packet time to detect the abnormal AP are proposed. The overview of the abnormal AP detection method is shown in FIG. 8 below. The abnormal detection method can be performed by either the WiFi STA or the AP. The TWT negotiation status can be determined by examining the TWT negotiation status flag in the WiFi chipset.

FIG. 8 illustrates an example method 800 for abnormal AP detection according to embodiments of the present disclosure. The embodiment of the method 800 for abnormal AP detection illustrated in FIG. 8 is for illustration only. FIG. 8 does not limit the scope of this disclosure to any particular implementation of the method for abnormal AP detection.

The abnormal AP detection may be performed every Δt seconds. A typical value of Δt can be 500 ms. At step 804, a network service detection module is utilized to detect if the current service is a real-time service. At step 806, a determination is made whether the current service is detected as a real-time service. If not, then the method reverts to step 802 and waits for Δt. If the current service is detected as a real-time service, then the method continues to step 808, where a determination is made whether TWT is negotiated. If the TWT is not negotiated, then the method reverts to step 802 and waits for Δt to check the abnormal AP status again. If the TWT is negotiated, then the method continues to step 810, where the method compares the current maximum downlink inter-packet time to a database of normal downlink inter-packet time. If abnormally large downlink inter-packet time is not detected, then the method reverts to step 802 and waits for Δt. If abnormally large downlink inter-packet time is detected, then the method continues to step 812, where the AP will be labeled as an abnormal AP, and thereafter continues to step 814, where the TWT will be torn down. After TWT tear down, the method reverts to step 802 and waits for Δt to check the abnormal AP status again.

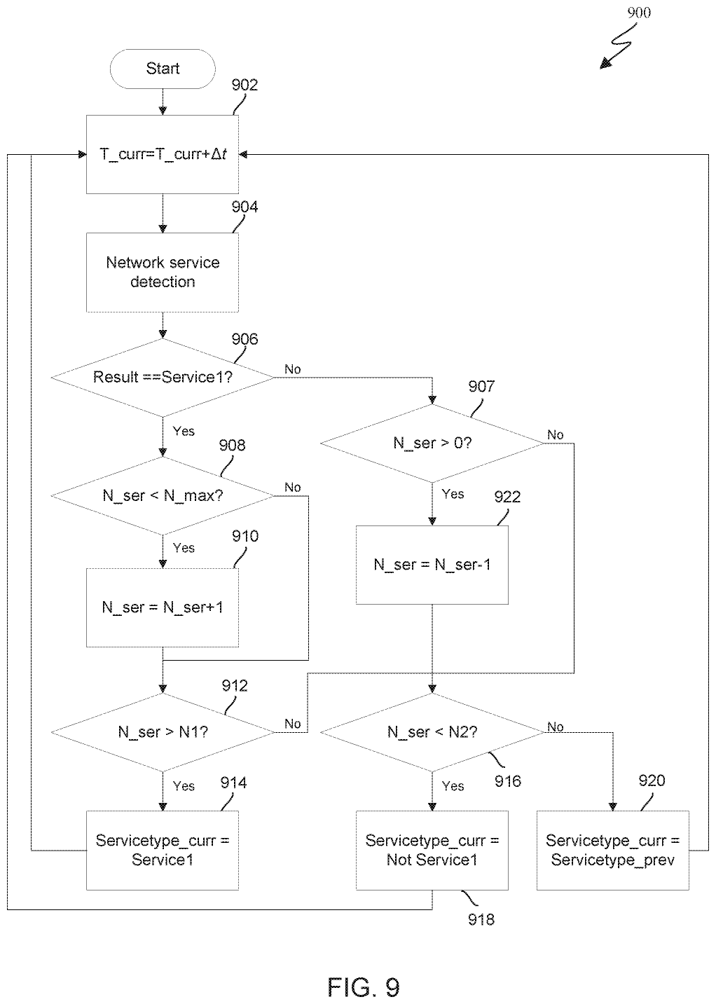

FIG. 9 illustrates an example method 900 for network service detection according to embodiments of the present disclosure. The embodiment of the method 900 for network service detection illustrated in FIG. 9 is for illustration only. FIG. 9 does not limit the scope of this disclosure to any particular implementation of the method for network service detection.

Because there can be some fluctuation of the network service detection result, such as some occasional false or misdetection of real-time service, it may be beneficial to increase the confidence level and stability of the network service detection result as shown in FIG. 9. Specifically, to minimize the impact of false/misdetection of the real-time service by the network service detection module, a more detailed description of how to confirm that the current service is a real-time service is illustrated in FIG. 9. The methods illustrated in FIGS. 8 and 9 may run concurrently. For the “Realtime Service?” block 806 illustrated in FIG. 8, it directly reads the Servicetype_curr result illustrated in FIG. 9 and makes the decision. The flow illustrated in FIG. 9 may always be running in parallel to the flow illustrated in FIG. 8 in the background.

As illustrated in FIG. 9, Service 1 is used to represent Real-time Service, as the illustrated method can be used for confirming not only Real-time Service but also all different kinds of other service types and subservice types. At step 904, the network service detection module is utilized to detect if the current running service is the desired Service 1 (e.g., real-time service) every Δt seconds. At step 906, a determination is made whether the current running service is detected as the desired Service 1. If the current running service is detected as the desired Service 1, then the method continues to step 908, where a determination is made whether the N_ser is smaller than N_max. If the N_ser is smaller than N_max, then at step 910 the value of N_ser is increased by 1 and the method continues to step 912. The value of N_max is typically determined by the max delays that can be tolerated when the current service changes to be no longer Service 1. For example, when such delay is determined to be 2 s, then N_max*Δt must be smaller than 2 seconds, and then N_max needs to be smaller than 4 given Δt=500 ms. The N_ser represents the number of times that Service 1 is detected in a moving window of size N_max*Δt and step size Δt. If the N_ser is not smaller than N_max, then the method continues to step 912, where a determination is made whether the value of N_ser becomes larger than a first threshold N1. If the value of N_ser becomes larger than the first threshold N1 (that is less than N_max), then the method continues to step 914 where it is confirmed that the current running service is Service 1, and then the method reverts to step 902 and waits for Δt. A typical value of N_max can be 5 and a typical value of N1 can be 4.

If N_ser is not larger than N1, then at step 916 a determination is made whether N_ser is smaller than a second threshold N2. If so, then at step 918 the service type can be determined to be not Service 1, and then the method reverts to step 902 and waits for Δt. If N_ser is smaller than N1 but still larger than N2, then at step 920 the final result of the detected service type (denoted as Servicetype_curr) is not updated and the previous result Servicetype_prev is used instead, and then the method reverts to step 902 and waits for Δt. The value of the second threshold N2 should be equal to or smaller than the first threshold N1. A typical value of N2 can be 3 or 4. After it is confirmed that the current service is the desired Service 1, the method can be used to check when the current service is no longer Service 1. If the network service detection module's output at step 906 is not Service 1, then at step 907 a determination is made whether the value of N_ser is greater than zero. If not, then the method continues to step 916. If yes, then at step 922 the value of N_ser is reduced by 1 (e.g., due to the moving window of size N_max*Δt and step size Δt) until it reaches 0. If N_ser becomes smaller than N2, then the current service is confirmed to be no longer Service 1 as described above.

For step 810 in FIG. 8 of checking whether the downlink interpacket time is abnormal, a database may be used to record the normal downlink interpacket time for different sub-service types (all of which are real-time services) under different network conditions. A typical database is illustrated in Table 1 below.

TABLE 1
Database of normal inter-packet
time for difference sub-service

| Congestion | Sub-service | | |
|---|---|---|---|
| level | Mobile gaming | Video call | Audio call |
| <0.3 | 190 ms | 260 ms | 490 ms |
| >=0.3 | 250 ms | 350 ms | 560 ms |

To obtain such tables above, experiments are conducted in the anechoic chamber. Several phones are used to generate different background traffic to control the congestion level. The DL inter-packet time of a set of apps in mobile gaming, video call and audio call categories are recorded while the apps are running without any observable quality of service issue. Among the recorded DL inter-packet time, we choose the maximum value of the recorded inter-packet time in each category and record them in the database. The congestion level is measured by the ratio of clear-channel-assessment time and the radio-on time. The clear-channel-assessment time is the time that WiFi radios use to sense the channel and wait for the channel to be clear. The radio-on time is the time that Wi-Fi radios are turned on and awake. The time in the table represents the maximum normal inter-packet time that each sub-service can have. If the observed maximum downlink inter-packet time of a specific sub-service is larger than the one in the database, then this downlink interpacket time can be considered abnormal.

Due to some fluctuation of server traffic pattern, the downlink interpacket time for those sub-services can sometimes be larger than the one recorded in the database. Thus, we develop another mechanism to further confirm that the there is indeed a problem with the observed downlink interpacket time.

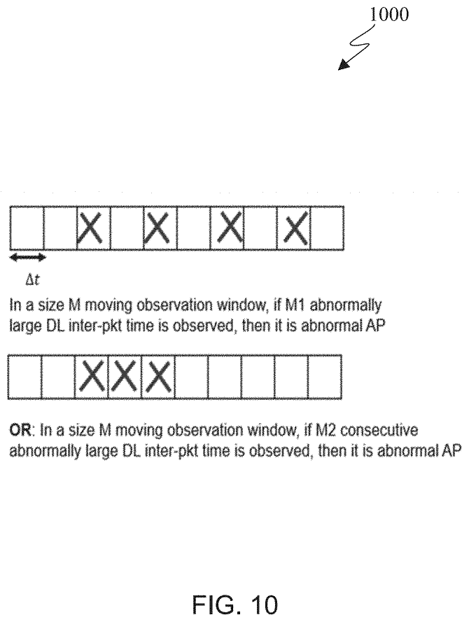

FIG. 10 illustrates an example 1000 for confirming abnormal downlink inter-packet time according to embodiments of the present disclosure. The embodiment of the example 1000 for confirming abnormal downlink inter-packet time illustrated in FIG. 10 is for illustration only. FIG. 10 does not limit the scope of this disclosure to any particular implementation of the example for confirming abnormal downlink inter-packet time.

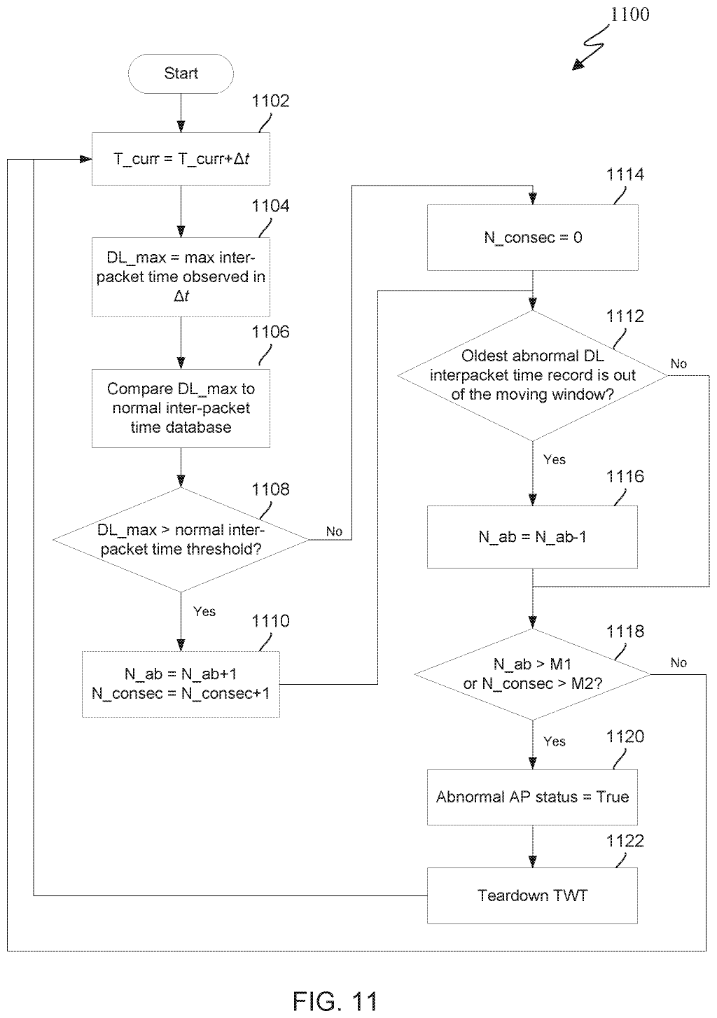

As illustrated in FIG. 10, the maximum downlink inter-packet time every Δt seconds can be recorded in a moving window of size M*Δt. The moving window's step size is Δt and the total number of steps is M. Within this M steps moving window, if M1 or a greater number of abnormally large downlink inter-packet time is observed or if M2 consecutive abnormally larger downlink interpacket time is observed, then it can be confirmed that the downlink inter-packet time for the current service is indeed abnormal and TWT should be torn down. An illustration of the method of using a database and a moving window to confirm that the current service is having an abnormal downlink inter-packet time is shown in FIG. 11.

FIG. 11 illustrates a method 1100 for confirming abnormal downlink inter-packet time according to embodiments of the present disclosure. The embodiment of the method 1100 for confirming abnormal downlink inter-packet time illustrated in FIG. 11 is for illustration only. FIG. 11 does not limit the scope of this disclosure to any particular implementation of the example method for confirming abnormal downlink inter-packet time.

As illustrated in FIG. 11, at step 1104, the maximum downlink inter-packet time every Δt seconds can be recorded in a moving window of size M*Δt. At step 1106, the maximum downlink inter-packet time is compared to the normal inter-packet time database, and at step 1108, a determination is made whether the maximum downlink inter-packet time is greater than a normal inter-packet time threshold. If yes, then at step 1110, the number of abnormally large downlink inter-packet time is increased by one and the number of consecutive abnormally larger downlink interpacket time is increased by one, and the method continues to step 1112. If not, then the method continues to step 1114 where the number of consecutive abnormally larger downlink interpacket time is set to zero, and then the method continues to step 1112. At step 1112, a determination is made whether an oldest abnormal downlink inter-packet time record is out of the moving window. If yes, then at step 1116, the number of abnormally large downlink inter-packet time is decreased by one and the method continues to step 1118. If not, then the method continues to step 1118. The moving window's step size is Δt and the total number of steps is M. Within this M steps moving window, at step 1118, if M1 or a greater number of abnormally large downlink inter-packet time is observed or if M2 consecutive abnormally larger downlink interpacket time is observed, then at step 1120 it can be confirmed that the downlink inter-packet time for the current service is indeed abnormal, at step 1122 the TWT should be torn down, and then the method reverts to step 1102 and waits for Δt. If neither M1 or a greater number of abnormally large downlink inter-packet time is observed nor M2 consecutive abnormally larger downlink interpacket time is observed, then the method reverts to step 1102 and waits for Δt.

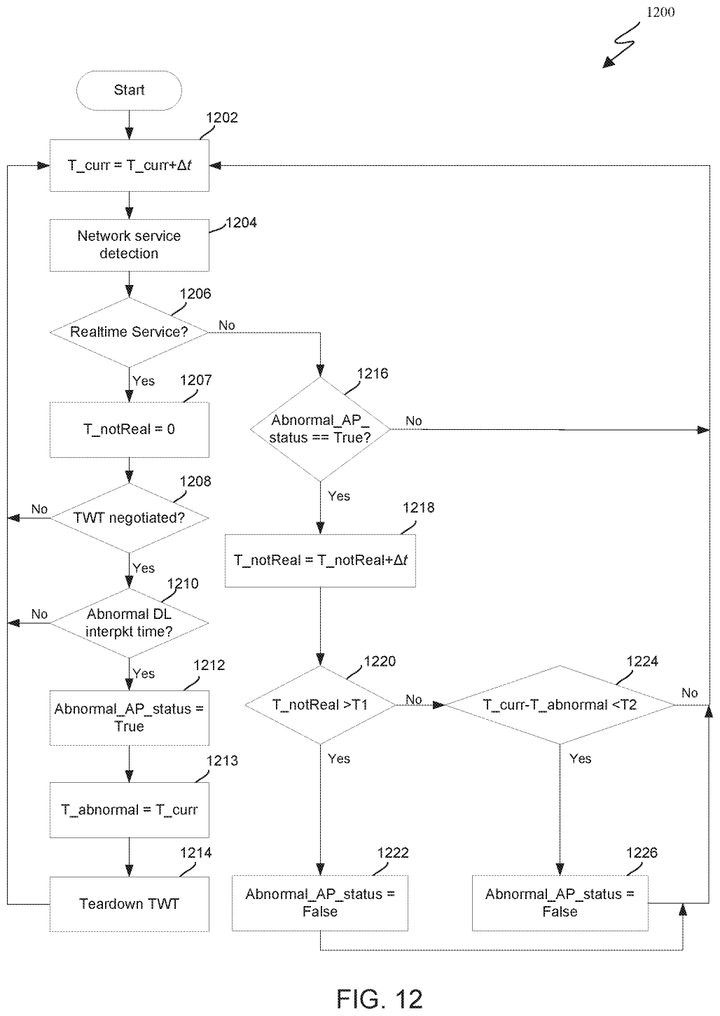

FIG. 12 illustrates an example method 1200 for abnormal AP detection according to embodiments of the present disclosure. The embodiment of the method 1200 for abnormal AP detection illustrated in FIG. 12 is for illustration only. FIG. 12 does not limit the scope of this disclosure to any particular implementation of the method for abnormal AP detection.

In another embodiment of abnormal AP detection, if the network service detection has a relatively high false detection or miss rate of the desired service, then additional procedures may be developed to mitigate the impact of the false detection rate or miss rate. In current TWT implementation, TWT is only enabled for real-time service. Thus, the detection of abnormal AP is only required for real-time service. As there can be some false abnormal AP detection, as illustrated in FIG. 12, a mechanism is introduced to reset the abnormal AP status to be false when the non-real-time service is detected for a period of time. T_notReal in FIG. 12 represents the amount of continuous time that the non-real-time service is detected, and real-time service is not present. If T_notReal is larger than a threshold T1, then it can be confirmed that the current running service is non-real time. Then the abnormal AP status can be reset to false in this scenario as the TWT function is torn down for non-real-time service.

In addition, sometimes the service detection can have some delay to detect non-real-time service. As non-real-time service typically has very large downlink interpacket time, when the service detection detects non-real-time service as real-time service, then it can falsely treat the downlink interpacket time of non-real-time service as the one from real-time service, and then decides that the inter-packet time is abnormally large. An additional measure is added which checks the time difference between the time that the abnormal AP is detected (T_abnormal) and the time that the non-real-time service is detected. As illustrated in FIG. 12, if T_curr−T_abnormal<T2, then it is likely that the previously detected abnormally large downlink inter-packet time is due to the false detection of non-real-time time service as real-time by the network service detection module, and the previously detected abnormal AP is a false detection. Thus, the abnormal AP status needs to be reset in this scenario.

As illustrated in FIG. 12, the abnormal AP detection may be performed every Δt seconds. A typical value of Δt can be 500 ms. At step 1204, a network service detection module is utilized to detect if the current service is a real-time service. At step 1206, a determination is made whether the current service is detected as a real-time service. If the current service is detected as a real-time service, then the method continues to step 1207 where T_notReal is set to zero. At step 1208, a determination is made whether TWT is negotiated. If the TWT is not negotiated, then the method reverts to step 1202 and waits for Δt to check the abnormal AP status again. If the TWT is negotiated, then the method continues to step 1210, where the method compares the current maximum downlink inter-packet time to a database of normal downlink inter-packet time. If abnormally large downlink inter-packet time is not detected, then the method reverts to step 1202 and waits for Δt. If abnormally large downlink inter-packet time is detected, then the method continues to step 1212, where the AP will be labeled as an abnormal AP, and thereafter continues to step 1213, where T_abnormal is set equal to T_curr, and thereafter continues to step 1214, where the TWT will be torn down. After TWT tear down, the method reverts to step 1202 and waits for Δt to check the abnormal AP status again.

If the determination at step 1206 is that the current service is not detected as a real-time service, a mechanism is introduced to reset the abnormal AP status to be false when the non-real-time service is detected for a period of time. At step 1216, a determination is made whether the abnormal AP status is set to true. If not, then the method reverts to step 1202 and waits for Δt to check the abnormal AP status again. If yes, then T_notReal is incremented by Δt and at step 1220, a determination is made whether T_notReal is larger than a threshold T1. If yes, then at step 1222, the abnormal AP status is set to be false, and the method reverts to step 1202 and waits for Δt to check the abnormal AP status again. If T_notReal is not larger than the threshold T1, then at step 1224, a determination is made whether T_curr-T_abnormal<T2. If yes, then at step 1226, the abnormal AP status is set to be false, and the method reverts to step 1202 and waits for Δt to check the abnormal AP status again. If not, the method reverts to step 1202 and waits for Δt to check the abnormal AP status again.

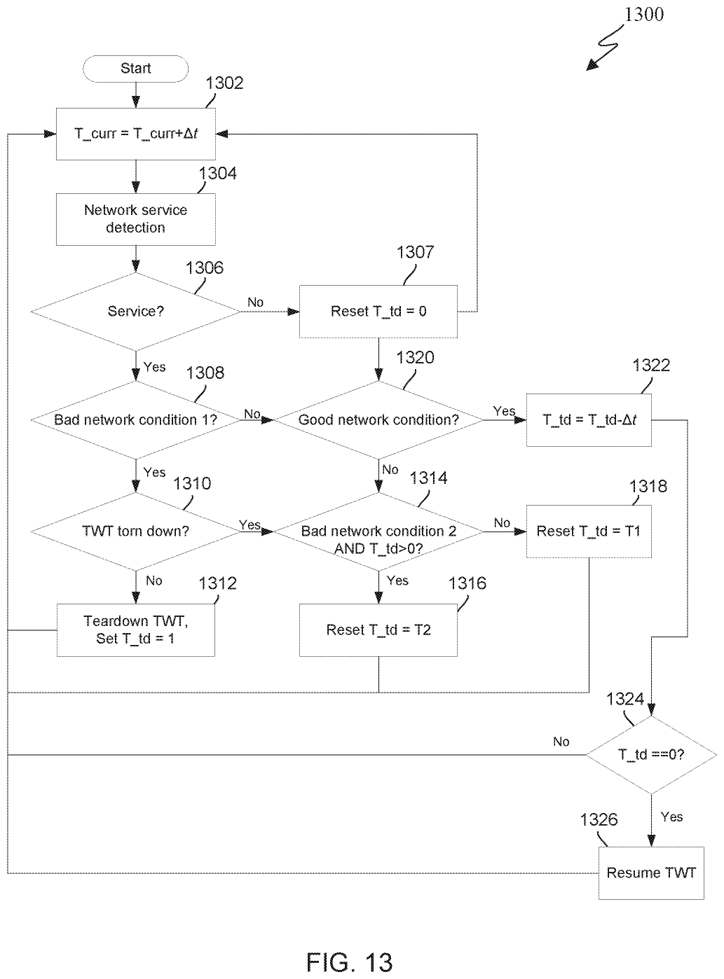

FIG. 13 illustrates an example method 1300 for network condition based TWT adjustment according to embodiments of the present disclosure. The embodiment of the method 1300 for network condition based TWT adjustment illustrated in FIG. 13 is for illustration only. FIG. 13 does not limit the scope of this disclosure to any particular implementation of the method for network condition based TWT adjustment.

There are some services such as mobile gaming whose QoS is susceptible to bad network conditions. Thus, the TWT needs to be disabled for those services when a bad network condition is discovered. The flowchart of the proposed network condition based TWT adjustment strategy is shown in FIG. 13. It is noted that in FIG. 13, non-real time service has no TWT teardown.

The T_td in FIG. 13 represents the time duration for which the TWT should be torn down. As such, T_td=0 means that the TWT is not torn down. The current service type and the network condition can be checked or updated every Δt seconds. A typical value of Δt can be 0.5 seconds. At step 1304, the network service detection is first performed and at step 1306, a determination is made whether the current running service is Service v1 (such as mobile gaming) which is susceptible to network condition. If Service 1 is not detected, then at step 1307 the teardown timer T_td is set to 0 and the method reverts to step 1302 and waits for Δt to check network conditions. If Service 1 is detected, then at step 1308, a determination is made whether a bad network condition 1 is detected. If the bad network condition 1 is detected, and if at step 1310 the TWT is not torn down, then at step 1312 the TWT is torn down and the TWT teardown timer T_td is set to be T1. A typical value of T1 is 30 seconds. Then the method reverts to step 1302 and waits for Δt to check network conditions. If at step 1310 the TWT is already torn down, then it means a bad network condition 1 has already been detected before, and then at step 1314 a determination is made whether a second bad network condition (bad network condition 2) is detected. The bad network condition 2 often represents a worse network condition than bad network condition 1. If the bad network condition 2 is detected, then at step 1316 the TWT teardown timer T_td is set to T2 which can be a larger value than T1. A typical value of T2 can be 15 minutes. If the bad network condition 2 is not detected at step 1314, then at step 1318, the teardown timer T_td is reset to be T1. If the bad network condition 1 is not detected at step 1308, then at step 1320, a determination is made whether a good network condition is detected to resume TWT. If the good network condition is detected, then at step 1322, the TWT teardown timer T_td is reduced by Δt. If the good network condition is constantly observed and T_td is reduced to 0 at step 1324, then at step 1326 the TWT is resumed. If the T_td is not reduced to 0 at step 1324, then the method reverts to step 1302 and waits for Δt to check network conditions.

In the example described above, the network condition may be measured by the congestion level and the transmission success rate (TxGoodRate). The congestion level is quantified by the ratio of clear channel assessment time and radio-on time (CCA/RO). The typical values of good and bad network conditions are shown below.
Good network condition: CCA/RO<0.3 AND TxGoodRate>0.8
Bad network condition 1: CCA/RO>0.39 OR TxGoodRate<0.7
Bad network condition 2: CCA/RO>0.48 OR TxGoodRate<0.63

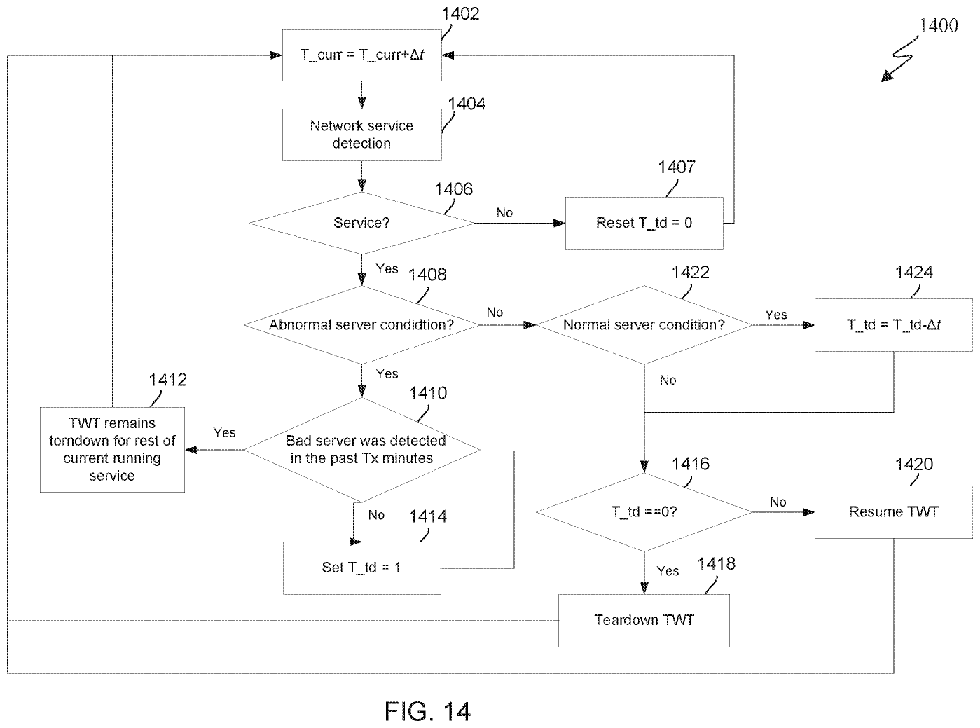

FIG. 14 illustrates an example method 1400 for abnormal server detection and TWT adjustment according to embodiments of the present disclosure. The embodiment of the method 1400 for abnormal server detection and TWT adjustment illustrated in FIG. 14 is for illustration only. FIG. 14 does not limit the scope of this disclosure to any particular implementation of the method for abnormal server detection and TWT adjustment.

Sometimes, a server may act abnormally and cause QoS issues at the user end. In this case, the TWT needs to be torn down to minimize its impact on the last hop to the user. The last hop is defined as the link between the access point and user's WiFi device. Therefore, a method to detect a server anomaly and then teardown TWT would be beneficial. The abnormal server can often cause abnormally large downlink interpacket time. Thus, in the present disclosure, the downlink interpacket time is used as a metric to detect an abnormal server event. Unlike the abnormal AP, the server issue can be short-lived, and the method described in the present disclosure does give it a chance to clear the abnormal server status if normal downlink interpacket time is constantly observed.

At step 1404, the network service detection is performed to identify if the current running services are the ones which are sensitive to any server issues (e.g., mobile gaming). At step 1406, a determination is made whether such services (using Service 1 to represent here) is/are detected. If Service 1 is not detected, then at step 1407 the teardown timer T_td is set to 0 and the method reverts to step 1402 and waits for Δt to check server conditions. If Service 1 is detected, then at step 1408, a determination is made whether the abnormal server condition 1 is detected. If the abnormal server condition 1 is detected, then at step 1410, a determination is made whether the abnormal server has been detected in the past Tx minutes. If so, then at step 1412, the TWT will remain torn down for the rest of the current running services, and then the method reverts to step 1402 and waits for Δt to check server conditions. A typical value of Tx can be 10 minutes. If the abnormal server condition 1 is not detected, or if it is the first time that a server issue has been discovered for the current running services, then at step 1414 the TWT teardown timer T_td will be torn down for at least T1 seconds. A typical value of T1 can be 30 seconds. At step 1416, a determination is made whether T_td is greater than zero. If yes, then at step 1418 the TWT will remain torn down, and if not, the TWT is resumed at step 1420. If the abnormal server condition 1 is not detected at step 1408, then at step 1422 a determination is made whether a normal server condition is met. If a normal server condition is met, then at step 1424 the T_td value will reduce by Δt. Example normal and abnormal server conditions are described below.

In one example abnormal server condition, the DL interpacket time for mobile gaming service is larger than 90 ms for 3 times in a size 20 moving window. Each window has a time length of 500 ms.

In one example normal server condition, the DL interpacket time for mobile gaming is smaller than 75 ms.

The above flowcharts illustrate example methods that can be implemented in accordance with the principles of the present disclosure and various changes could be made to the methods illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A communication device comprising:
a transceiver configured to receive information including packets associated with a target wake time (TWT); and
a processor operably coupled with the transceiver, the processor configured to:
determine a network service type based on the packets, and
when the determined network service type is a real-time service type:
determine whether a condition associated with the TWT is satisfied, and
modify the TWT based on the condition.

2. The communication device of claim 1, wherein to determine whether the condition associated with the TWT is satisfied, the processor is configured to:
determine whether the TWT has been negotiated between the communication device and another communication device; and
when the TWT has been negotiated between the communication device and the other communication device, compare a downlink inter-packet time at the communication device with a threshold time that is obtained based on a subservice type and a congestion level.

3. The communication device of claim 2, wherein when the downlink inter-packet time is greater than the threshold time, the processor is configured to modify TWT parameters negotiated between the communication device and the other communication device.

4. The communication device of claim 1, wherein to determine whether the condition associated with the TWT is satisfied, the processor is configured to:
determine whether a first network condition is satisfied;
when the first network condition is satisfied, modify the TWT for a first time duration;
when the first network condition is not satisfied:
determine whether a second network condition is satisfied, and
determine whether a third network condition is satisfied;
when the second network condition is not satisfied and the third network condition is satisfied, modify the TWT for a second time duration greater than the first time duration; and
when the second network condition is not satisfied and the third network condition is not satisfied, modify the TWT for the first time duration.

5. The communication device of claim 4, wherein:
the processor is configured, when the second network condition is satisfied, to modify the TWT for a third time duration less than the first time duration, and
the first network condition, the second network condition, and the third network condition are each based on a congestion level and a transmission success rate.

6. The communication device of claim 1, wherein to determine whether the condition associated with the TWT is satisfied, the processor is configured to:
determine whether a first server condition is satisfied; and
when the first server condition is satisfied:
modify the TWT for a first time duration when detection of the first server condition being satisfied occurs within a threshold time duration, and
modify the TWT for a duration of a remaining current running service session when detection of the first server condition being satisfied does not occur within the threshold time duration.

7. The communication device of claim 6, wherein:
when the first server condition is not satisfied, the processor is configured to determine whether a second server condition is satisfied, and
when the second server condition is not satisfied, the processor is configured to modify the TWT until a TWT modify time counter reaches a value of zero.

8. A method for operating a communication device, the method comprising:
receiving information including packets associated with a target wake time (TWT);
determining a network service type based on the packets; and
when the determined network service type is a real-time service type:
determining whether a condition associated with the TWT is satisfied, and
modifying the TWT based on the condition.

9. The method of claim 8, further comprising:
determining whether the TWT has been negotiated between the communication device and another communication device; and
when the TWT has been negotiated between the communication device and the other communication device, comparing a downlink inter-packet time at the communication device with a threshold time that is obtained based on a subservice type and a congestion level.

10. The method of claim 9, wherein when the downlink inter-packet time is greater than the threshold time, modifying TWT parameters negotiated between the communication device and the other communication device.

11. The method of claim 8, further comprising:
determining whether a first network condition is satisfied;
when the first network condition is satisfied, modifying the TWT for a first time duration;
when the first network condition is not satisfied:
determining whether a second network condition is satisfied, and
determining whether a third network condition is satisfied;
when the second network condition is not satisfied and the third network condition is satisfied, modifying the TWT for a second time duration greater than the first time duration; and
when the second network condition is not satisfied and the third network condition is not satisfied, modifying the TWT for the first time duration.

12. The method of claim 11, further comprising:
when the second network condition is satisfied, modifying the TWT for a third time duration less than the first time duration, and
wherein the first network condition, the second network condition, and the third network condition are each based on a congestion level and a transmission success rate.

13. The method of claim 8, further comprising:
determining whether a first server condition is satisfied; and
when the first server condition is satisfied:
modifying the TWT for a first time duration when detection of the first server condition being satisfied occurs within a threshold time duration, and
modifying the TWT for a duration of a remaining current running service session when detection of the first server condition being satisfied does not occur within the threshold time duration.

14. The method of claim 13, further comprising:
when the first server condition is not satisfied, determining whether a second server condition is satisfied, and
when the second server condition is not satisfied, modifying the TWT until a TWT modify time counter reaches a value of zero.

15. A non-transitory, computer readable medium comprising instructions that, when executed by a processor of a communication device, cause the communication device to:
receive information including packets associated with a target wake time (TWT);
determine a network service type based on the packets; and
when the determined network service type is a real-time service type:
determine whether a condition associated with the TWT is satisfied, and
modify the TWT based on the condition.

16. The computer readable medium of claim 15, further comprising instructions that, when executed by the processor, cause the communication device to:
determine whether the TWT has been negotiated between the communication device and another communication device;
when the TWT has been negotiated between the communication device and the other communication device, compare a downlink inter-packet time at the communication device with a threshold time that is obtained based on a subservice type and a congestion level; and
when the downlink inter-packet time is greater than the threshold time, modify TWT parameters negotiated between the communication device and the other communication device.

17. The computer readable medium of claim 15, further comprising instructions that, when executed by the processor, cause the communication device to:
determine whether a first network condition is satisfied;
when the first network condition is satisfied, modify the TWT for a first time duration;
when the first network condition is not satisfied:
determine whether a second network condition is satisfied, and
determine whether a third network condition is satisfied;
when the second network condition is not satisfied and the third network condition is satisfied, modify the TWT for a second time duration greater than the first time duration; and
when the second network condition is not satisfied and the third network condition is not satisfied, modify the TWT for the first time duration.

18. The computer readable medium of claim 17, further comprising instructions that, when executed by the processor, cause the communication device to:
when the second network condition is satisfied, modify the TWT for a third time duration less than the first time duration, and
wherein the first network condition, the second network condition, and the third network condition are each based on a congestion level and a transmission success rate.

19. The computer readable medium of claim 15, further comprising instructions that, when executed by the processor, cause the communication device to:
determine whether a first server condition is satisfied; and
when the first server condition is satisfied:
modify the TWT for a first time duration when detection of the first server condition being satisfied occurs within a threshold time duration, and
modify the TWT for a duration of a remaining current running service session when detection of the first server condition being satisfied does not occur within the threshold time duration.

20. The computer readable medium of claim 19, further comprising instructions that, when executed by the processor, cause the communication device to:
when the first server condition is not satisfied, determine whether a second server condition is satisfied, and
when the second server condition is not satisfied, modify the TWT until a TWT modify time counter reaches a value of zero.
